(19) United States
(12) Patent Application Publication
(10) Pub. No.: US 2009/0150585 A1
(43) Pub. Date: Jun. 11, 2009

(54) Connecting an integrated antenna in a flat panel display to a desktop computer

(76) Inventor: Michael Haines, Hillsboro, OR (US)

Correspondence Address: INTEL CORPORATION;c/o CPA Global, P.O. BOX 52050, MINNEAPOLIS, MN, 55402, US

(21) Appl. No.: 11/953,624

(22) Filed: Dec. 10, 2007

(51) Int. Cl. G06F 13/42; G06F 1/16; H01R 9/05; H01R 12/00

(52) U.S. Cl. 710/106; 439/578; 439/79

(57) ABSTRACT

A connector containing data pins for video signals and a coax pin for an antenna signal can permit a personal computer (PC) to use an integrated antenna in an external display device, with a single connector providing both video and radio frequency communication signals between those two devices. This connector may be used in place of the standard 15-pin VGA connector. In various embodiments, this connector may be contained in the PC, in the external display device, or in both. In some embodiments, this connector may be in an adaptor cable for use between the PC and the external display device.

### BACKGROUND

For personal computers (PCs), wireless connectivity to the Internet is becoming more and more widespread. As a result, most new portable PC's are being manufactured with an antenna integrated into the flat panel display housing for wireless connectivity to various wireless networks. Unfortunately, there is a large installed base of desktop computers that were not designed with wireless capability. Although a wireless card can be installed in the desktop computer, it requires connection to an external antenna before the computer can communicate over a wireless network. This typically requires a standalone antenna and another cable (to the antenna), both of which add cost and add to the jumble of wires on the desk.

### BRIEF DESCRIPTION OF THE DRAWINGS

Some embodiments of the invention may be understood by referring to the following description and accompanying drawings that are used to illustrate embodiments of the invention. In the drawings:

FIG. 1 shows a layout of the pins in a connector, according to an embodiment of the invention.

FIG. 2 shows a display device with an integrated antenna for facilitating wireless communications, according to an embodiment of the invention.

FIG. 3 shows an adapter, according to an embodiment of the invention.

FIG. 4 shows a cable, according to an embodiment of the invention.

FIGS. 5, 6, 7 show various ways of connecting a PC to a display having an integrated antenna, according to various embodiments of the invention.

FIG. 8 shows a flow diagram of a method, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The term “wireless” and its derivatives may be used to describe circuits, devices, systems, methods, techniques, communications channels, etc., that communicate data by using modulated electromagnetic radiation through a non-solid medium. The term does not imply that the associated devices do not contain any wires, although in some embodiments they might not. The term “mobile wireless device” is used to describe a wireless device that may be in motion while it is communicating.

In various embodiments of the invention, a connector containing data pins for video signals and also containing a coax pin for an antenna signal can permit a personal computer (PC) to use an integrated antenna in an external display, with a single connector providing both video and radio frequency (RF) communication signals between those two devices. This connector may be used in place of the standard 15-pin VGA connector. This combination connector may be located in the PC and/or in the display device and/or in an adapter cable between those two devices.

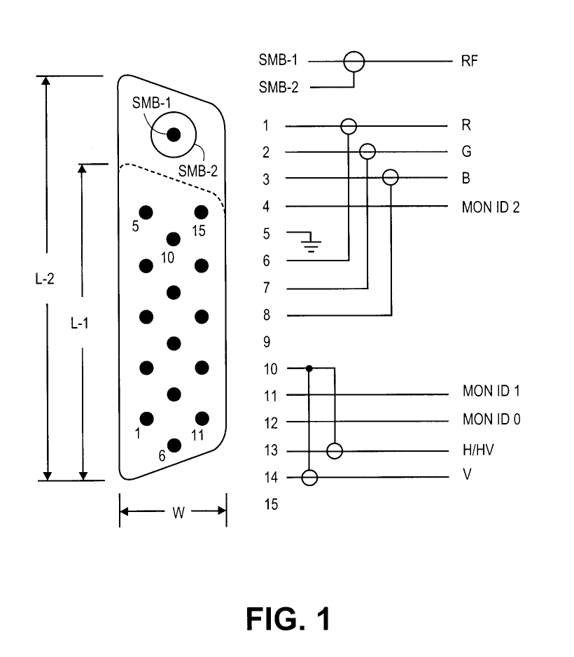

FIG. 1 shows a layout of the pins in a connector, according to an embodiment of the invention. The pin layout of data pins 1-15, the connector width (W), and a length (L-1) may correspond to that of a standard VGA connector. VGA connectors were developed by IBM in the 1980's, and have become an industry standard for video in PCs. Assignments for the pins are shown next to the physical layout. Red, green, and blue signals are on pins 1, 2, and 3, respectively, with their shields being connected to pins 6, 7, and 8, respectively. Vertical sync is on pin 14, and while horizontal sync (or in some cases a combined horizontal/vertical sync) is on pin 13. The shields for the sync pins are connected to pin 10. Pin 5 is a general ground pin, while pins 4, 11, and 12 may be used for monitor ID signals (e.g., when multiple monitors are connected in parallel to a common VGA port, but they receive different video input). Specific embodiments may modify these pin assignments slightly (e.g., eliminating monitor ID, using other pins for ground and/or shield connections, etc.), without departing from the scope of the invention.

In the novel embodiments of the invention, the length of the connector may be increased to length L-2, to accommodate a coaxial pin. The coaxial pin, and the associated coax cable that can be connected to it, may be configured to handle RF signals with a frequency of at least 2.5 gigahertz (GHz). In some embodiments, the coaxial pin may conform to the requirements of the well-known SubMiniature version B coax, commonly known in the industry as SMB. The center conductor of this coax connection is labeled SMB-1, while the shield connection is labeled SMB-2, although these labels do not imply that every embodiment must conform to the SMB standard. Data pins 1-15, as well as coax pin SMB, may be of either the male or female variety, depending on the configuration of the specific equipment. Although the illustration shows the coax pin at the end of the connector nearest to pins 5, 10, and 15, other embodiments may have the coax pin at the end of the connector nearest to pins 1, 6, and 11.

The connector may be physically configured so that a standard VGA connector will mate with it (see dashed lines between the data pins and coax pin for the end of a standard VGA connector). In some embodiments, a coax connector may mate with the SMB pin while a standard VGA connector is mated to the data pins, and both video and RF signals may pass through the connector simultaneously. In other embodiments, only one of these two connectors may mate with it at a time.

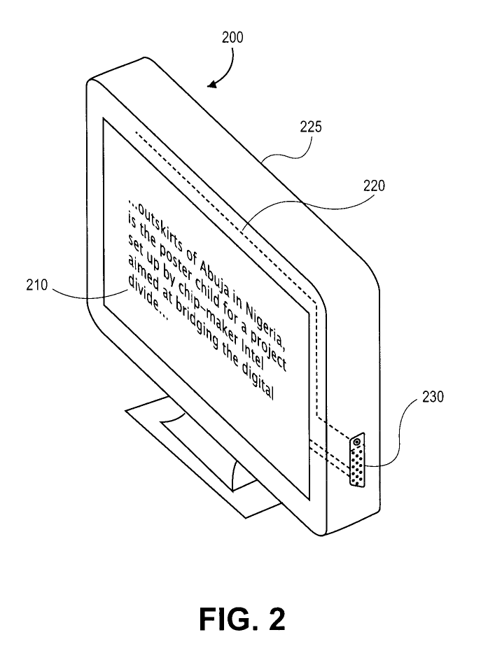

FIG. 2 shows a display device with an integrated antenna for facilitating wireless communications, according to an embodiment of the invention. The illustrated display device 200 contains a display 210, which may use any feasible display technology, such as but not limited to LED, plasma, CRT, etc. The device 200 also contains an antenna 220 integrated into the display housing 225. The antenna 220 may have any feasible antenna configuration, such as but not limited to dipole, monopole, slot, etc. Both the display 210 and the antenna 220 may be connected to one or more connectors 230. Through connector(s) 230, the display 210 may be connected to and controlled by a computer (not shown). Similarly, the antenna 220 may be connected through connector(s) 230 to a computer, which may communicate wirelessly with other devices through antenna 220. The display device 200 is distinguished from some other devices in that it does not contain a general-purpose computer system, such as would be the case with a notebook computer that had its own integrated display and antenna. Display device 200 is intended as an external display device for such computer systems.

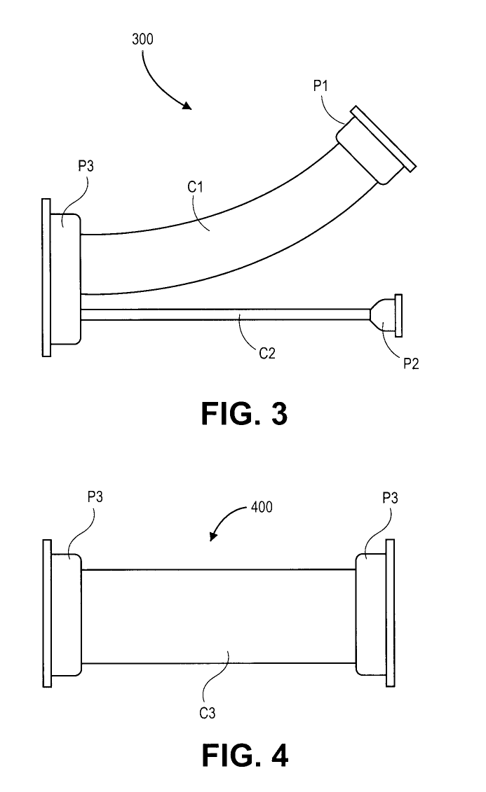

FIG. 3 shows an adapter, according to an embodiment of the invention. This adapter 300 may be used when the PC has a connector with the combination layout shown in FIG. 1, but the display/antenna device does not. Alternately, the adapter 300 may be used when the display/antenna device has a connector with the combination layout shown in FIG. 1, but the PC does not. In the illustrated embodiment, a VGA connector P1 may be used to connect to a standard VGA port, while a standard coax connector P2 may be used to connect to a standard radio frequency wireless connection (e.g., to an SMB connector). These are each connected, through respective cable wiring assemblies C1 and C2, to a combination connector P3, such as that shown in FIG. 1. The pins of the VGA connector P1 (those pins that are used) may be connected to their like-numbered pins in connector P3. Similarly, the coax pin in P2 may be connected to the coax pin in P3.

Although cable wiring assemblies C1 and C2 are shown as physically separate wiring assemblies, in some embodiments they may be integrated into a single cable wiring assembly for at least part of their length. Each of cable wiring assemblies C1 and C2 may be of any feasible length, and in some embodiments they may not be the same length. In still other embodiments, either or both of cable wiring assemblies C1 and C2 may be eliminated, with connector P1 and/or P2 being part of an integrated assembly with connector P3.

FIG. 4 shows a cable, according to an embodiment of the invention. In the illustrated cable 400, two connectors P3 may be connected to each other with cable wiring assembly C3. This configuration may be used when this cable connects a PC to a display device having an integrated antenna, when both the PC and the display/antenna have connectors with the combination pin layout shown in FIG. 1. The pins of each connector P3 may be connected to the corresponding pins in the other P3.

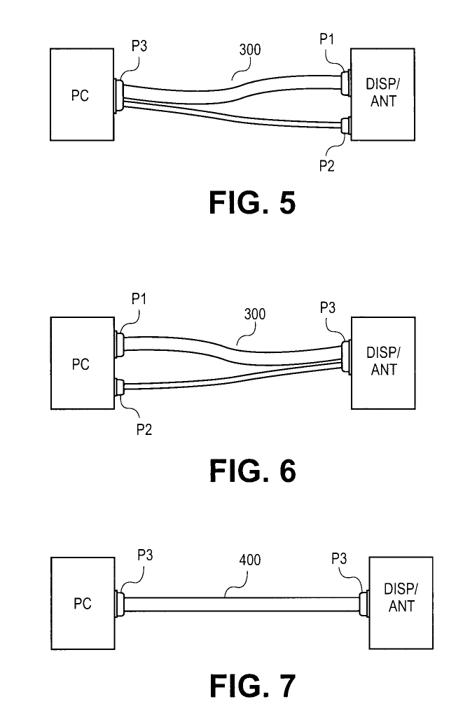

FIGS. 5, 6, and 7 show various ways of connecting a PC to a display having an integrated antenna, according to various embodiments of the invention. In FIG. 5, a PC having a connector with a pin layout as shown in FIG. 1 may be connected to a display/antenna device that has separate connectors for the video input and antenna connection, using the adapter 300 of FIG. 3. In FIG. 6, a PC having separate connectors for the video output and antenna connection may be connected to a display/antenna device that has a connector with the pin layout as shown in FIG. 1, again using the adapter 300 of FIG. 3. In FIG. 7, both the PC and the display/antenna device have a connector with the pin layout as shown in FIG. 1, and they can be connected with the cable of FIG. 4.

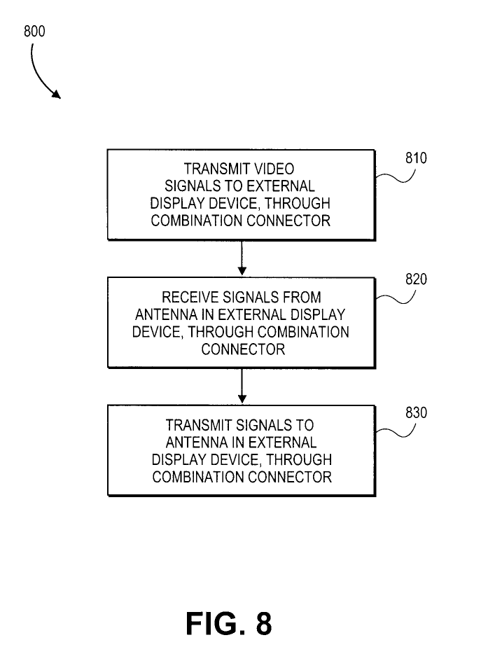

FIG. 8 shows a flow diagram of a method, according to an embodiment of the invention. In flow diagram 800, at 810 a computer device may transmit video signals through a combination connector to a display device that is external to the computer device. A combination connector, as the term is used herein, is a single connector that handles both video signals to a display and wired radio frequency (RF) signals between an antenna and the computer device. At 820, the computer may receive wired RF signals through the combination connector from the antenna. These signals may be the signals that allow the computer to communicate in a wireless network (e.g., WLAN, WiMAX, etc.) and/or allow the computer to communicate with nearby devices (e.g., Bluetooth), through the antenna. At 830, the computer device may transmit wired RF signals through the combination connector to the antenna. Again, this communication may be part of communicating in a wireless network and/or communicating with local devices.

The foregoing description is intended to be illustrative and not limiting. Variations will occur to those of skill in the art. Those variations are intended to be included in the various embodiments of the invention, which are limited only by the spirit and scope of the following claims.

What is claimed is:

1. An apparatus, comprising
a personal computer containing a connector, the connector comprising:
multiple data pins for carrying video signals for a video display device; and
a coaxial pin for carrying radio frequency (RF) signals to and from an antenna embedded in the video display device.

2. The apparatus of claim 1, wherein the multiple data pins have a layout corresponding to a VGA connector pin layout.

3. The apparatus of claim 1, wherein the coaxial pin is an SMB pin.

4. (canceled)

5. The apparatus of claim 1, further comprising a detachable cable to connect the connector to the video display device with the integrated antenna.

6-15. (canceled)

16. A method, comprising:
transmitting, through a connector, signals from a personal computer to a video display;
receiving, through the connector, a radio frequency signal from an antenna integrated into the video display.

17. The method of claim 16, wherein said transmitting comprises transmitting the signals for the video display through pins having an arrangement corresponding to an arrangement defined for a VGA connector.

18. The method of claim 16, wherein said receiving comprises receiving the radio frequency signal through an SMB pin.

19. The method of claim 16, wherein said transmitting and said receiving are occurring simultaneously.

20. An apparatus, comprising
a display to visually present video data;
a housing containing the display;
an antenna integrated into the housing; and
a connector attached to the housing and having multiple pins electrically connected to the display to carry video signals from a personal computer to the display and having a coaxial pin electrically connected to the antenna to carry radio frequency signals between the antenna an the personal computer;
wherein the apparatus does not contain a computer system.

21. (canceled)

22. The apparatus of claim 20, wherein the connector is configured to mate with a VGA connector.

23. The apparatus of claim 20, wherein the connector is configured to mate with an SMB connector.
